(19) United States
(12) Patent Application Publication
(10) Pub. No.: US 2012/0313472 A1
(43) Pub. Date: Dec. 13, 2012

(54) MAGNETIC PARTICLE INDUCED PLUGGING RESISTANT MAGNETIC COUPLING

(75) Inventor: Eckard Scholz, Eldingen (DE)

(73) Assignee: Baker Hughes Incorporated, Houston, TX (US)

(21) Appl. No.: 13/158,604

(22) Filed: Jun. 13, 2011

(51) Int. Cl. H02K 49/10

(52) U.S. Cl. 310/104

(57) ABSTRACT

A magnetic coupling includes an inner mover including an inner magnet region including a plurality of magnets disposed in circular arrangement around an axis of rotation. The coupling also includes an outer mover surrounding the inner magnet region, the outer mover including an outer component and an inner component, wherein the inner component and outer component are separated from each other in a first location and a second location. The coupling further includes a first magnet disposed in the first location and having a first polarity and a second magnet disposed in the second location adjacent to the first magnet and having a second polarity opposite the first magnet. The first and second magnets each include two endpoints and have a depth measured from an inner magnet surface to an outer magnet surface measured in a radial direction extending from the axis of rotation, the depth decreases from a maximum value to a minimum value, the minimum value being measured at the endpoints.

### BACKGROUND

1. Field of the Invention

The present invention generally relates to magnetic couplings and, in particular, to a magnetic coupling having improved resistance to the accumulation of magnetic particles therein.

2. Description of the Related Art

Magnetic couplings can be used to transmit rotary motion from one rotatable element to another. A typical magnetic coupling includes two movers. The first mover surrounds a portion of the second mover. The first and second movers both includes magnets in the region where they overlap. As is known in the art, the magnets are arranged such that rotation of one of the shafts causes the other shaft to rotate due to attraction and repulsive forces between the magnets.

One advantage of magnetic couplings is that they can transmit rotary motion from one mover to another without the two movers physically contacting each other. This can be useful in situations where a shaft or other mover located in the sealed environment needs to be rotated. An example of such a case can occur in context of drilling a borehole into the earth. In such a case, a bottom hole assembly (BHA) of drill string may require power. The power can be generated by an alternator in the BHA. Given the harsh conditions that exist in a borehole, it is desirable to ensure that the alternator is protected from and enclosed in a sealed environment. To this end, a magnetic coupling can be attached to the shaft. The magnetic coupling includes an inner rotor having magnets surrounded by an outer housing that also includes magnets. The outer housing can be coupled to the alternator such that the combination forms a sealed environment. The outer housing is fixedly coupled to a turbine. Drilling mud is pumped through the turbine causing it, the outer housing and an outer housing of the alternator to rotate. The magnets in the outer housing and the magnets on the rotor interact such that the rotation of the outer housing causes the rotor to rotate. The rotation can be used to generate electricity for the BHA.

### BRIEF SUMMARY

Disclosed is a magnetic coupling including an axis of rotation. The magnetic coupling includes an inner mover including an inner magnet region including a plurality of magnets disposed in circular arrangement around the axis of rotation and a separator layer surrounding the inner magnet region. The coupling also includes an outer mover surrounding the inner magnet region and separated from the inner magnet region by the separator layer. The outer mover includes an outer component and an inner component separated from each other in a first location and a second location. The coupling further includes a first magnet disposed in the first location and having a first polarity and a second magnet disposed in the second location adjacent to the first magnet and having a second polarity opposite the first magnet. The first and second magnets each include two endpoints and have a depth measured from an inner magnet surface to an outer magnet surface measured in a radial direction extending from the axis of rotation, the depth decreases from a maximum value to a minimum value, the minimum value being measured at the endpoints.

Also disclosed is a magnetic coupling including an axis of rotation. The magnetic coupling includes an inner mover including an inner magnet region including a plurality of magnets disposed in circular arrangement around the axis of rotation and a separator layer surrounding the inner magnet region. The magnetic coupling also includes an outer mover surrounding the inner magnet region and separated from the inner magnet region by the separator layer. The outer mover includes an outer component and an inner component with the inner component including a cylindrical inner surface and an outer surface having a plurality of outer edges defining a geometric shape and disposed within the outer component to define a plurality of volumes between the edges and the outer component.

Further disclosed is an outer mover that includes an outer component and an inner component where the inner component and outer component are separated from each other in a first location and a second location. The outer mover also includes a first magnet disposed in the first location and having a first polarity and a second magnet disposed in the second location adjacent to the first magnet and having a second polarity opposite the first magnet. The first and second magnets each include two endpoints and have a depth measured from an inner magnet surface to an outer magnet surface measured in a radial direction extending from the axis of rotation, the depth decreasing from a maximum value to a minimum value, the minimum value being measured at the endpoints.

### BRIEF DESCRIPTION OF THE DRAWINGS

The following descriptions should not be considered limiting in any way. With reference to the accompanying drawings, like elements are numbered alike:

FIG. 1 is a perspective cross-sectional view of a prior art magnetic coupling that includes magnetic particles built up between the inner and outer mover;

FIG. 2 is a perspective cross-sectional view of an outer mover for a magnetic coupling according to an embodiment of the present invention; and

FIG. 3 is an end view of an outer magnet.

### DETAILED DESCRIPTION

A detailed description of one or more embodiments of the disclosed apparatus and method presented herein is by way of exemplification and not limitation with reference to the Figures.

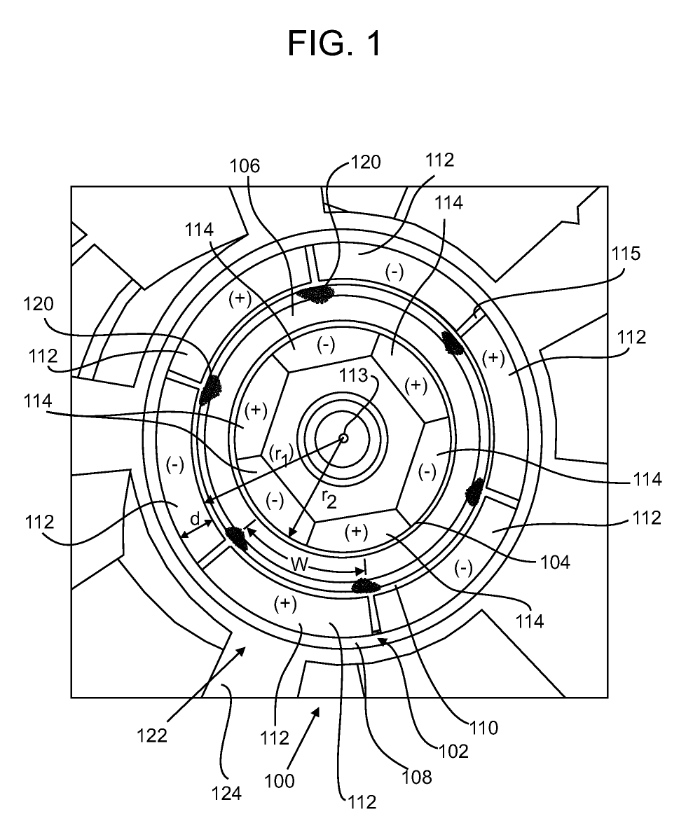

FIG. 1 illustrates a prior art magnetic coupling 100. The illustrated magnetic coupling 100 includes an outer mover 102 that surrounds an inner mover 104. The outer mover 102 is separated from the inner mover 104 by a separator layer 106. The outer and inner movers 102, 104 can be configured and arranged such that they both rotate about a same axis of rotation denoted in FIG. 1 as center point 113. While the following description includes separator layer 106, it shall be understood that the separator layer 106 can be omitted in any of the embodiments disclosed herein. In such a case, drilling mud, oil, or a combination thereof may be present between inner mover 104 and the outer mover 104.

The outer mover 102 includes inner and outer walls 108, 110 that are both substantially circular in cross section. Outer magnets 112 are arranged between the inner and outer walls 108, 110. As is known in the art, the outer magnets 112 are arranged in a roughly circular pattern about the center point 113 of the magnetic coupling 100. Thus, as illustrated the inner wall 108 (and, hence, in inner side of each magnet 112) is at a substantially constant first radial distance r₁ from the center point 113.

Each outer magnet 112 can be physically separated from adjacent magnets by dividers 115. As illustrated, the dividers 115 are part of the inner wall 108. Of course, the dividers 115 could be formed as part of the outer wall 110. The polarity of each of the outer magnets 112 alternates around the circumference of the outer mover 102. In this example, the polarity of the outer magnets 112 is denoted by the (+) and (−) designations. As illustrated, the outer mover 102 is surrounded by a turbine 122 that causes the outer mover 102 to rotate when a gas or liquid is caused to pass over blades 124 thereof.

Similar to the outer mover 102, the inner mover 104 includes inner magnets 114 arranged around center point 113 to define a roughly circular shape with a circumference located as a substantially constant second radial distance r₂ from the center point 113. As in the outer mover 102, the polarity of adjacent inner magnets 114 alternates around the circumference of the inner mover 104. Generally, rotation of the outer mover 102 will cause the inner mover 104 to rotate due to attractive/repulsive forces between the outer and inner magnets 112, 114.

The arrangement shown in FIG. 1, the outer magnets 112 each have a uniform depth (d). The uniform thickness of the outer magnets 112 leads to a substantially uniform magnetic strength at any location along its width (w). As configured, the gradient of the magnetic field is increased at the junction of two outer magnets 112 of opposing polarity. That is, the gradient of the magnetic field is greater near the dividers 115 than in other locations. This increased magnetic gradient can cause magnetic particles 120 to collect at or near the dividers 115. Of course, if the dividers are not present, the particles 120 would collect at or near where adjacent outer magnets 112 meet or nearly meet. If enough particles 120 collect, the resulting collection can create friction between the outer mover 102 and the separator layer 106. This friction can eventually reduce or halt rotation of the outer mover 104 or cause wear on the separator layer 106.

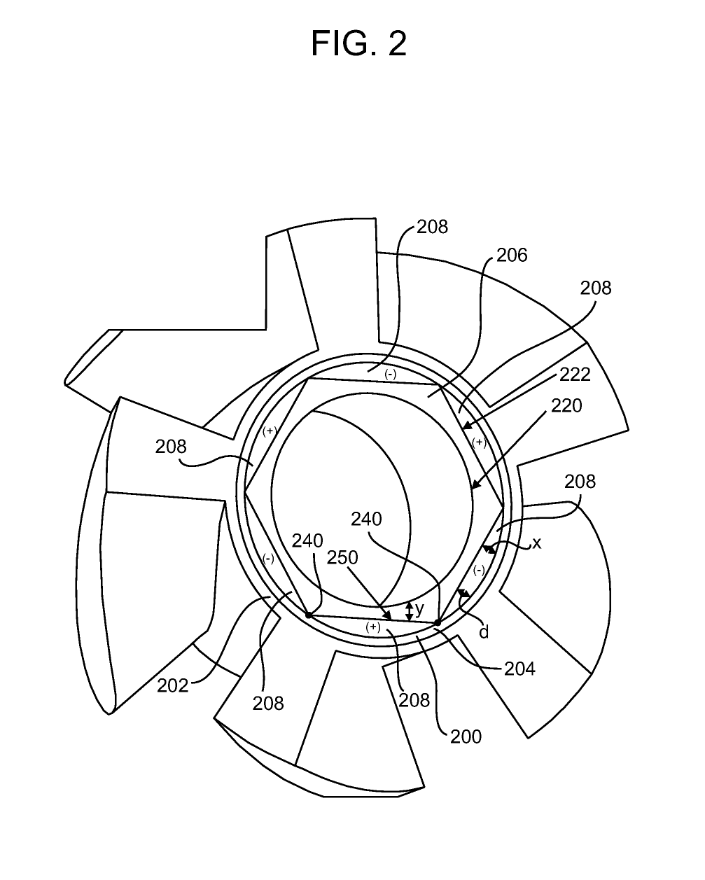

FIG. 2 illustrates an embodiment of an outer mover 200 according to an embodiment of the present invention. In this embodiment, the outer mover 200 is surrounded by an optional turbine 202. Of course, the turbine 202 is not required and can be omitted. While not illustrated, it shall be understood that the outer mover 200 can be arranged and configured to surround a magnet region of an inner mover that is physically separated from the outer mover 200 by a separator layer. For example, the outer mover 200 could replace the outer mover 102 illustrated in FIG. 2. Advantageously, when configured as illustrated in FIG. 2, the outer mover 200 is less likely to collect magnetic particles between it and a separator layer than in the prior art. In addition, it should be understood that while the outer mover 200 could also be utilized as part of other devices that have an internally rotating core. For example, the outer mover 200 could be the stator of alternator surrounding a rotor having coils of magnets disposed thereon.

The outer mover 200 includes an outer component 204 at least partially surrounding an inner component 206. Outer magnets 208 of differing polarity are disposed between the outer component 204 and the inner component 206. In one embodiment, the inner component 206 has an inner surface 220 with a substantially circular cross-section. That is, in one embodiment, the inner surface 220 is cylindrical. The inner component 206 of this embodiment also includes an outer surface 222. The outer surface 222 does not have to have a circular cross-section. In the illustrated embodiment, the outer surface 222 has a hexagonal cross-section. However, the cross-section of the outer surface 222 can take on any shape and, in some cases, has a geometric shape, the number of sides (outer edges) of which is equal to the number of magnets 208 of the outer mover 200. In one embodiment, corners of the outer surface 222 separate endpoints 240 of adjacent outer magnets 208.

In one embodiment, the outer surface 222 is formed such that a distance x between it and the outer component 204 varies inversely to a distance from an endpoint 240 of a particular magnet 208 measured along the outer surface 222 from one endpoint 240 to another endpoint 240. Stated in an alternative manner, the distance y between the inner surface 220 and the inner magnet surface 250 (or outer surface 222) varies inversely with the distance for an closest of two endpoints 240 measured along the outer surface 222.

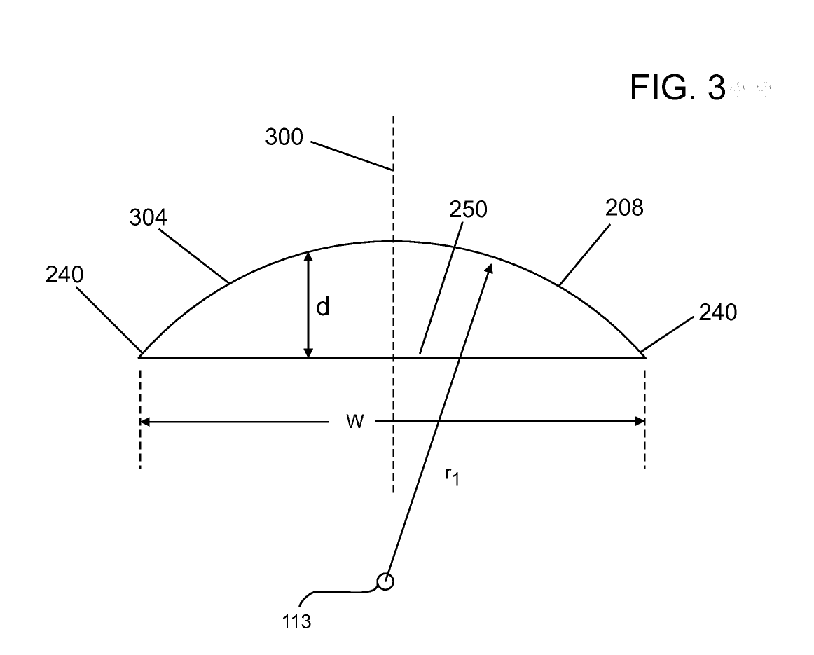

In one embodiment, the shape of the outer magnets 208 is roughly the same as the space between the outer surface 222 and the outer component 204. That is, each outer magnetic 208 can have a depth (d) that varies in the same manner as distance x. In the illustrated embodiment, each magnet 208 includes two endpoints 240. Thus, the depth (d) varies along the width (w) of each outer magnet 208 in the same manner that x varies between the endpoints 240. d and w are shown in more detail in FIG. 3.

In one embodiment, one endpoint 240 of one outer magnet 208 is arranged proximate another endpoint 240 of another, adjacent outer magnet 208. In the prior art, the location where two magnets came together was a location of where the gradient of the magnetic field strength was at its highest. Here, that location is removed from the inner surface 220 so that magnetic particles are less likely to accumulate near that specific location. In addition, because the depth of the outer magnets 208 varies proportionally to the distance x, the outer magnets 208 are thinnest near the endpoints 240. As such, the magnetic strength of the outer magnets 208 is reduced near the endpoints 240. Further, the magnetic field gradient between adjacent outer magnets 208 is reduced based on the reduced depth (d) reduces the magnetic fields produced at or near endpoints 240. Thus, in combination with the endpoints 240 being removed from the inner surface 220, the reduced magnetic field strength at the endpoints can lead to further reduction of accumulation of magnetic particles. Indeed, finite element analysis has predicted that, as compared to the configuration illustrated in FIG. 1, the amount of particle accumulation can be reduced by 96% while a decrease of only 40% in the maximum torque that can safely exist between the outer and inner movers is experienced.

FIG. 3 is an end view of an outer magnet 208 according to one embodiment. The outer magnet 208 includes a variable depth (d) that increases the closer to a midline 300 the measurement is made. In one embodiment, the midline 300 is halfway between endpoints 240 of the outer magnet.

The outer magnet 208 includes an outer surface 304 that is generally a segment of a circle having radius r₁ from center point 113. That is, the outer surface 304 is arcuate in one embodiment. The center point 113 represents an axis of rotation of an outer mover (not shown) in which the outer magnet 208 is disposed. The outer magnet 208 also includes an inner magnet surface 250 that is substantially planar and extends between endpoints 240. As one of ordinary skill will realize, the inner magnet surface 250 defines a chord of the circle having radius r₁ and center point 113.

Elements of the embodiments have been introduced with either the articles “a” or “an.” The articles are intended to mean that there are one or more of the elements. The terms “including” and “having” are intended to be inclusive such that there may be additional elements other than the elements listed. The conjunction “or” when used with a list of at least two terms is intended to mean any term or combination of terms. The terms “first,” “second,” and “third” are used to distinguish elements and are not used to denote a particular order.

It will be recognized that the various components or technologies may provide certain necessary or beneficial functionality or features. Accordingly, these functions and features as may be needed in support of the appended claims and variations thereof, are recognized as being inherently included as a part of the teachings herein and a part of the invention disclosed.

While the invention has been described with reference to exemplary embodiments, it will be understood that various changes may be made and equivalents may be substituted for elements thereof without departing from the scope of the invention. In addition, many modifications will be appreciated to adapt a particular instrument, situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A magnetic coupling including an axis of rotation, the magnetic coupling comprising:
an inner mover including an inner magnet region including a plurality of magnets disposed in circular arrangement around the axis of rotation;
a separator layer surrounding the inner magnet region;
an outer mover surrounding the inner magnet region and separated from the inner magnet region by the separator layer, the outer mover including an outer component and an inner component, wherein the inner component and outer component are separated from each other in a first location and a second location;
a first magnet disposed in the first location and having a first polarity; and
a second magnet disposed in the second location adjacent to the first magnet and having a second polarity opposite the first magnet;
wherein the first and second magnets each include two endpoints and have a depth measured from an inner magnet surface to an outer magnet surface measured in a radial direction extending from the axis of rotation, the depth decreases from a maximum value to a minimum value, the minimum value being measured at the endpoints.

2. The magnetic coupling of claim 1, wherein the maximum value is measured at a centerline located between the endpoints.

3. The magnetic coupling of claim 1, wherein the outer magnetic surface is arcuate.

4. The magnetic coupling of claim 1, wherein the inner magnet surface is planar.

5. The magnetic coupling of claim 1, wherein an endpoint of the first magnet is located adjacent to an endpoint of the second magnet.

6. The magnetic coupling of claim 1, wherein the inner component includes a cylindrical inner surface and an outer surface having a cross-section that defines a geometric shape.

7. The magnetic coupling of claim 6, wherein the first magnet is disposed between the outer surface and the outer component.

8. The magnetic coupling of claim 1, wherein the outer surface separates an endpoint of the first magnet from an endpoint of the second magnet.

9. A magnetic coupling including an axis of rotation, the magnetic coupling comprising:
an inner mover including an inner magnet region including a plurality of magnets disposed in circular arrangement around the axis of rotation;
a separator layer surrounding the inner magnet region;
an outer mover surrounding the inner magnet region and separated from the inner magnet region by the separator layer, the outer mover including an outer component and an inner component, the inner component includes a cylindrical inner surface and an outer surface having a plurality of outer edges defining a geometric shape and disposed within the outer component to define a plurality of volumes between the edges and the outer component.

10. The magnetic coupling of claim 9, further comprising:
a first magnet disposed in a first volume of the plurality of volumes and having a first polarity; and
a second magnet disposed in a second volume of the plurality of volumes adjacent the first volume and having a second polarity opposite the first magnet.

11. The magnetic coupling of claim 10, wherein the first magnet include a planar surface extending between edges of the first magnet, wherein the edges are further from the cylindrical inner surface than at least other location on the planar surface.

12. The magnetic coupling of claim 9, wherein the outer surface separates an endpoint of the first magnet from an endpoint of the second magnet.

13. An outer mover comprising:
an outer component and an inner component, wherein the inner component and outer component are separated from each other in a first location and a second location;
a first magnet disposed in the first location and having a first polarity; and
a second magnet disposed in the second location adjacent to the first magnet and having a second polarity opposite the first magnet;
wherein the first and second magnets each include two endpoints and have a depth measured from an inner magnet surface to an outer magnet surface measured in a radial direction extending from the axis of rotation, the depth decreases from a maximum value to a minimum value, the minimum value being measured at the endpoints.
